(19) United States
(12) Patent Application Publication
(10) Pub. No.: US 2005/0050135 A1
(43) Pub. Date: Mar. 3, 2005

(54) Handheld digital multimedia workstation and method

(76) Inventor: Josef Hallermeier, Assling (DE)

Correspondence Address: LAUBSCHER SEVERSON, 1160 SPA RD, SUITE 2B, ANNAPOLIS, MD, 21403, US

(21) Appl. No.: 10/647,717

(22) Filed: Aug. 25, 2003

(51) Int. Cl. G06F 15/16

(52) U.S. Cl. 709/200

(57) ABSTRACT

A Personal Digital Assistant functions as a high fidelity multimedia recorder with software employing a double buffering method that permits simultaneous reading of incoming data and writing of data to memory. An asynchronous I/O extension layer provided in a software application is provided between the operating system layer and the application layer of a commercially available PDA. The layer permits a PDA normally capable only of synchronous file I/O file access operation to operate in an asynchronous file I/O access mode.

### BACKGROUND OF THE INVENTION

The present invention relates to the field of multimedia signals processing, and more specifically to a method and system for providing professional quality digital multimedia processing in a handheld device such as a personal digital assistant (PDA).

Speed and efficiency in the daily work environment is of fundamental importance for the success and survival of any individual or organization who participates in the highly competitive journalistic radio and multimedia-for-TV marketplace. Accordingly, digital automation systems began to be introduced into the radio broadcasting market as early as 1989, with the television market following soon after. Today, almost every area in the radio and multimedia-for-TV marketplace successfully implements computer-based solutions to achieve these goals. For example, an item of original content such as a Presidential statement can be once imported into an automated system and made immediately available to all editors of a broadcasting station. With the touch of a button it can be sent to a news desk for immediate broadcast.

Until recently, one critical segment of the multimedia broadcast chain has failed to keep pace with the rapid increases in speed and efficiency resulting from digital automation, particularly in the area of news reporting. The missed components are specifically, the on-the-scene reporters. This first step in the entire workflow of the creation of the “content” used for broadcasting includes all text, audio and images that become the original “content for the news report.” The utility of this content is totally dependent on the quality of the material collected in this process. Having the proper tools to perform this critical function is paramount to the success or failure of any broadcast content contribution.

Presently, reporters in the field rely on magnetic tape or mini-disk recorders with an external microphone to initially record the audio portion of a news, sports, or similar event. The captured audio is then fed into a laptop computer for further processing and transmission to a broadcast facility. Software applications have been developed for the laptop environment to provide on-site editing capability for text, audio and video. The integration and use of these devices and applications are necessarily complex and difficult to use and manage. The physical weight of a news field kit that includes a laptop computer, a recorder, a microphone, cables, extra batteries and a carrying case is commonly between seven and ten pounds. Laptop computers used for this purpose are complex and costly, largely because they require powerful (commonly CISC based) processors that support native multi-threading to run the available multimedia processing software.

Journalists also commonly carry a PDA because of its light weight, ease of use, and multifunction capability. PDAs have a less powerful (commonly RISC based) microcomputer processor that does not support native multi-threading and employs operating systems and application software that are limited in capability by the memory size and the base functionality of the architecture. Additional limitations of such processors include a lower clocking frequency, less powerful Input/Output (I/O) components, and less powerful memory interfaces. While present PDA single threaded architectures employing synchronous file I/O access are sufficient to support a rich set of text applications and non-broadcast quality multimedia playback, they are too slow to support professional digital signal ingest and the real-time display of status information.

It is well known that a processor “write” command on common PDA peripheral devices requires significantly more execution time than a “read” command, often in a ratio of as much as five to one. If “writing” incoming information to memory proceeds too slowly to keep up with the incoming information, as is particularly common when recording audio or video information, the delay shows up as audible or visible gaps in the recording. The delay also eliminates the ability to deliver status information in real time. As recording quality (bandwidth) increases, the gaps tend to become even more noticeable because of the increased amount of data required for greater fidelity.

Larger, faster microprocessors utilizing native multi-thread capability deal relatively easily with the above problem. Single-threaded processor environments, however, do not. By definition, a single thread processor environment will operate on only one thread at a time. If two threads, such as one containing incoming multimedia data and one containing real-time status information, simultaneously seek attention, the thread controller within the operating system will designate one or the other as having priority. That thread executes before execution of the other thread can begin. While a status information thread is executing, data arriving for input will be blocked and lost, with a resulting loss of signal fidelity. As a result, PDAs and similar consumer products typically have low quality recording capabilities. The prior art has normally been optimized for digital signal output only, i.e. the file I/O read operation.

### BRIEF DESCRIPTION OF THE PRIOR ART

Solutions to eliminating the gap or pause described above that employ multi-threaded capabilities are well known in the prior art. Typical of such solutions is that found in published U.S. patent application publication No. 2002/0032719 to Thomas et al. It describes and solves a problem associated with stack-type memories wherein stored data must be tracked for subsequent use. As the stack gets bigger, the time required for tracking increases. Because it is essential that no data in the stack be altered during the tracking process, execution of the thread must be suspended and a noticeable pause may occur. The disclosed solution permits a thread to continue execution if it is determined that the thread is not attempting to use a portion of the stack required by the thread. Also disclosed is a method for determining when a previously allocated buffer can be freed for subsequent use.

U.S. Pat. No. 6,505,229 to Turner et al. similarly describes a method by which multiple application threads share processing bandwidth efficiently. It also describes a method for releasing previously allocated system resources to make them available for current processes. The solutions employed by these and other known prior art references are inapplicable to the type of processors employed in present PDAs.

There is a need in the journalism and other industries for a compact and light weight, professional quality workstation that provides near real-time high fidelity digital capture, storage, editing, indexing, and transmission of multimedia content. There is a further need for multimedia workstation software that can be utilized in PDAs utilizing low-cost single-threaded microprocessors and operating system architectures such as the Microsoft PocketPC/Windows Mobile Operating System.

### SUMMARY OF THE INVENTION

Accordingly, it is an object of the present invention to provide a digital multimedia workstation having full processing capability utilizing a combination of recording and processing buffers.

It is a further object to provide a digital multimedia workstation having full processing capability within a single-threaded architecture. The present invention provides a solution to the above-identified needs by providing a method, computer program product, and system for professional, broadcast-quality multimedia recording with a PDA or similar handheld computer employing a single thread microprocessor environment. In accordance with one embodiment of the invention, a method of processing digital information includes receiving digital information at an input connected to a recording buffer. The recording buffer is filled with information and monitored to determine whether it is filled. The contents of the filled recording buffer are transferred to a processing buffer. The contents of the processing buffer are monitored to determine whether a predetermined amount of the processing buffer is filled, at which time the contents of the processing buffer are written to a storage medium.

In accordance with another embodiment of the invention, a method of processing digital information includes receiving digital information at an input connected to a recording buffer segment. The recording buffer segment is filled with information and monitored to determine whether the recording buffer segment it is filled. The contents of the filled recording buffer segment are transferred to a processing buffer, which is monitored to determine whether a predetermined amount of the processing buffer is filled. When the predetermined amount is reached, the contents of the processing buffer are written to a storage medium.

In accordance with another embodiment of the invention, digital information is received at an input switchably connected to a plurality of recording buffers, the buffers being filled sequentially. Simultaneously, the buffers are monitored to determine whether any recording buffer is filled. Each filled recording buffer is sequentially transferred to a processing buffer and the processing buffer is monitored to determine whether a predetermined amount of the processing buffer is filled. The contents of the processing buffer are written to a storage medium when the predetermined amount of the processing buffer has been filled.

In accordance with an alternative embodiment of the invention, a method of processing digital information includes receiving digital information at an input switchably connected to a plurality of recording buffers. The recording buffers are sequentially filled with information while being monitored to determine whether any recording buffer is filled. The contents of each filled recording buffer are sequentially transferred to a processing buffer. The processing buffer is monitored to determine whether a predetermined amount of the processing buffer is filled, and the contents of the processing buffer are written to a storage medium when a predetermined amount of the processing buffer has been filled. The receipt of digital information is monitored to determine when receipt of digital information is completed. At that time, the contents of each filled and unfilled recording buffer is sequentially transferred to the processing buffer and the contents of the processing buffer are written to a storage medium.

In accordance with still another embodiment of the invention, a method of processing digital information includes receiving digital information at an input switchably connected to a plurality of recording buffers. The recording buffers are sequentially filled with information and monitored to determine whether a predetermined number of recording buffers are filled. When the predetermined number of recording buffers is filled, the contents of the recording buffers are sequentially transferred to a processing buffer. The processing buffer is monitored to determine whether a predetermined amount of the processing buffer is filled and, when the predetermined amount is reached, the contents of the processing buffer are written to a storage medium.

In accordance with another embodiment of the invention, a method of processing digital information includes receiving digital information at an input switchably connected to a plurality of recording buffers. The recording buffers are sequentially filled and the contents of each filled recording buffer are transferred to a processing buffer. The processing buffer is monitored to determine whether a predetermined amount of the processing buffer is filled. When the predetermined amount has been reached, the contents of the processing buffer are written to a storage medium.

In accordance with another embodiment of the invention, a method of processing digital information includes receiving digital information at an input switchably connected to a plurality of recording buffers. The recording buffers are filled with information and monitored to determine whether a recording buffer is filled. The contents of the filled recording buffer is transferred to processing buffer, which is monitored to determine whether a predetermined amount of the processing buffer is filled. Upon the predetermined amount being reached, the contents of the processing buffer are written to a storage medium and the next recording buffer begins to fill.

In accordance with another embodiment of the invention, a PDA program product comprising a PDA usable medium having control logic stored therein for causing a PDA to record digital multimedia information includes PDA readable program code for causing the PDA to receive digital information at an input connected to a recording buffer. Additional PDA readable program code causes the PDA to fill the recording buffer with information. Further PDA readable program code causes the PDA to monitor the recording buffer to determine whether it is filled. Still further PDA readable program code causes the PDA to transfer the contents of the filled recording buffer to a processing buffer, while additional PDA readable program code causes the PDA to monitor the processing buffer to determine whether a predetermined amount of the processing buffer is filled. Additional PDA readable program code causes the PDA to write the contents of the processing buffer to a storage medium when a predetermined amount of the processing buffer has been filled.

In accordance with another embodiment of the invention, a PDA program product comprising a PDA usable medium having control logic stored therein for causing a PDA to record digital multimedia information includes PDA readable program code that causes the PDA to receive digital information at an input connected to a recording buffer segment. Additional PDA readable program code causes the PDA to fill the recording buffer segment with information. Still additional PDA readable program code causes the PDA to monitor the recording buffer segment to determine whether it is filled, while additional PDA readable program code causes the PDA to transfer the contents of the filled recording buffer segment to a processing buffer. Further PDA readable program code causes the PDA to monitor the processing buffer to determine whether a predetermined amount of the processing buffer is filled, and still further PDA readable program code causes the PDA to write the contents of the processing buffer to a storage medium when a predetermined amount of the processing buffer has been filled.

In accordance with another embodiment of the invention, a PDA program product comprising a PDA usable medium having control logic stored therein for causing a PDA to record digital multimedia information includes PDA readable program code that causes the PDA to receive digital information at an input switchably connected to a plurality of recording buffers. Further PDA readable program code causes the PDA to sequentially fill the recording buffers with information. Additional PDA readable program code causes the PDA to monitor the recording buffers to determine whether any recording buffer is filled. Additional PDA readable program code causes the PDA to sequentially transfer the contents of each filled recording buffer to a processing buffer. Still additional PDA code causes PDA to monitor the processing buffer to determine whether a predetermined amount of the processing buffer is filled, and additional PDA readable program code causes the PDA to write the contents of the processing buffer to a storage medium when a predetermined amount of the processing buffer has been filled.

In accordance with still another embodiment of the invention, a PDA program product having a PDA usable medium with control logic stored therein for causing a PDA to record digital multimedia information includes PDA readable program code that causes the PDA to receive digital information at an input switchably connected to a plurality of recording buffers. Additional PDA readable program code causes the PDA to sequentially fill the recording buffers with information. Further PDA readable program code causes the PDA to monitor the recording buffers to determine whether any recording buffer is filled. Additional PDA readable program code causes the PDA to sequentially transfer the contents of each filled recording buffer to a processing buffer, and further PDA readable program code causes the PDA to monitor the processing buffer to determine whether a predetermined amount of the processing buffer is filled. Additional PDA readable program code causes the PDA to write the contents of the processing buffer to a storage medium when a predetermined amount of the processing buffer has been filled, and further PDA readable program code causes the PDA to monitor the receipt of digital information to determine when receipt of digital information is completed. Additional PDA readable program code causes the PDA to, upon such determination, sequentially transfer the contents of each filled and unfilled recording buffer to the processing buffer, and further PDA readable program code causes the PDA to write the contents of the processing buffer to a storage medium.

In accordance with a still further embodiment of the invention, a PDA program product having a PDA usable medium with control logic stored therein for causing a PDA to record digital multimedia information includes PDA readable program code to cause the PDA to receive digital information at an input switchably connected to a plurality of recording buffers. Additional PDA readable program code causes the PDA to sequentially fill the recording buffers with information, and further PDA readable program code causes the PDA to monitor the recording buffers to determine whether a predetermined number of recording buffers are filled. Further PDA readable program code causes the PDA to sequentially transfer the contents of each filled recording buffer to a processing buffer, while additional PDA readable program code causes the PDA to monitor the processing buffer to determine whether a predetermined amount of the processing buffer is filled. Additional PDA readable program code causes the PDA to write the contents of the processing buffer to a storage medium when a predetermined amount of the processing buffer has been filled.

In accordance with another embodiment of the invention, a PDA program product having a PDA usable medium with control logic stored therein for causing a PDA to record digital multimedia information includes PDA readable program code to cause the PDA to receive digital information at an input switchably connected to a plurality of recording buffers. Additional code causes the PDA to sequentially fill the recording buffers with information, while further PDA readable program code causes the PDA to sequentially transfer the contents of each filled recording buffer to a processing buffer. Additional PDA readable program code causes the PDA to monitor the processing buffer to determine whether a predetermined amount of the processing buffer is filled, and additional PDA readable program code causes the PDA to write the contents of the processing buffer to a storage medium when a predetermined amount of the processing buffer has been filled.

In accordance with a further embodiment of the invention, a PDA program product having a PDA usable medium with control logic stored therein for causing a PDA to record digital multimedia information includes PDA readable program code that causes the PDA to receive digital information at an input switchably connected to a plurality of recording buffers. Additional PDA readable program code causes the PDA to fill a recording buffer with information, and further PDA readable program code causes the PDA to monitor the recording buffers to determine whether a recording buffer is filled. Additional PDA readable program code causes the PDA to transfer the contents of a filled recording buffer to a processing buffer, while further PDA readable program code causes the PDA to monitor the processing buffer to determine whether a predetermined amount of the processing buffer is filled. Additional PDA readable program code causes the PDA to write the contents of the processing buffer to a storage medium, and further PDA readable program code causes the PDA to switch to a next recording buffer for filling.

### BRIEF DESCRIPTION OF THE DRAWINGS

Other objects and advantages of the invention will become apparent from a study of the following specification when viewed in light of the accompanying drawing, in which:

FIG. 1 is a block diagram illustrating a system architecture incorporating an embodiment of the present invention and showing connectivity among various components;

FIG. 2 illustrates a PDA programmed in accordance with an embodiment of the invention and showing a screen shot generated by the graphical user interface of the recorder module;

FIG. 3 illustrates a PDA programmed in accordance with an embodiment of the invention and showing a screen shot generated by the graphical user interface of the present invention in content management mode;

FIG. 4 illustrates a PDA programmed in accordance with an embodiment of the invention and showing a screen shot generated by the graphical user interface of the editor module;

FIG. 5 illustrates a PDA programmed in accordance with an embodiment of the invention and showing a screen shot generated by the graphical user interface of the transfer agent module;

FIG. 6 is a timing diagram illustrating synchronous file I/O access representative of the prior art;

FIG. 7 is a timing diagram illustrating asynchronous file I/O access in accordance with an embodiment of the invention; and

FIGS. 8-12 are flowcharts depicting the operation and control flow of the file I/O access for various embodiments of the present invention.

### DESCRIPTION OF THE PREFERRED EMBODIMENTS

Embodiments of the present invention described below include a method, computer program product and system for providing high quality digital recording, editing and transfer using a PDA or similar small multifunction device employing a single threaded microcomputer processor system environment. The invention has particular value to journalists, reporters, and others who need a small, lightweight, broadcast quality recording device for on-the-spot capture of newsworthy multimedia content. It provides capability for immediate scripting, editing, and indexing of the content, and transmission of the content to an editor or broadcast studio for public broadcast.

When the invention is utilized in a handheld PDA utilizing a prior art operating system and conventional applications such as appointment calendar, note pad, and contact lists, a reporter is provided with a compact multi-functional reporting device offering fully integrated digital audio and text processing capability. A dynamic file system, which can be either loaded into the operating system kernel or installed as a direct part of the executable program, that additionally provides high bandwidth recording, storage and simultaneous status information output. The applications program includes a thread that encapsulates the file I/O (input/output) operations. The file I/O streaming extension: a) becomes an extension to the operating system kernel file I/O routines and is reserved exclusively for the I/O processing; b) provides flexible control to avoid access violations between the operating system kernel and the I/O applications in the shared memory areas; c) implements a multilayer configurable and highly optimized caching algorithm for enhanced reliability and to protect data integrity in unexpected field situations (e.g., interruptions due to other high priority application requirements or kernel operations, temporary storage failure, etc.); and d) creates an environment for the file I/O streaming operations needed for full asynchronous operation. As a result, other parts of the application, such as real-time status information output, can continue immediately after the file I/O operation has been initiated.

In an alternative embodiment, the present invention is connected by a network to a complete news broadcasting facility for seamless integrated collection, pre-editing, transmission, indexing, storage, editing and broadcast of multimedia news content.

The invention is described in terms of the above examples. However, it should be understood that the present invention is not limited to these specific examples and that one skilled in the art that the invention may also be implemented in alternative embodiments.

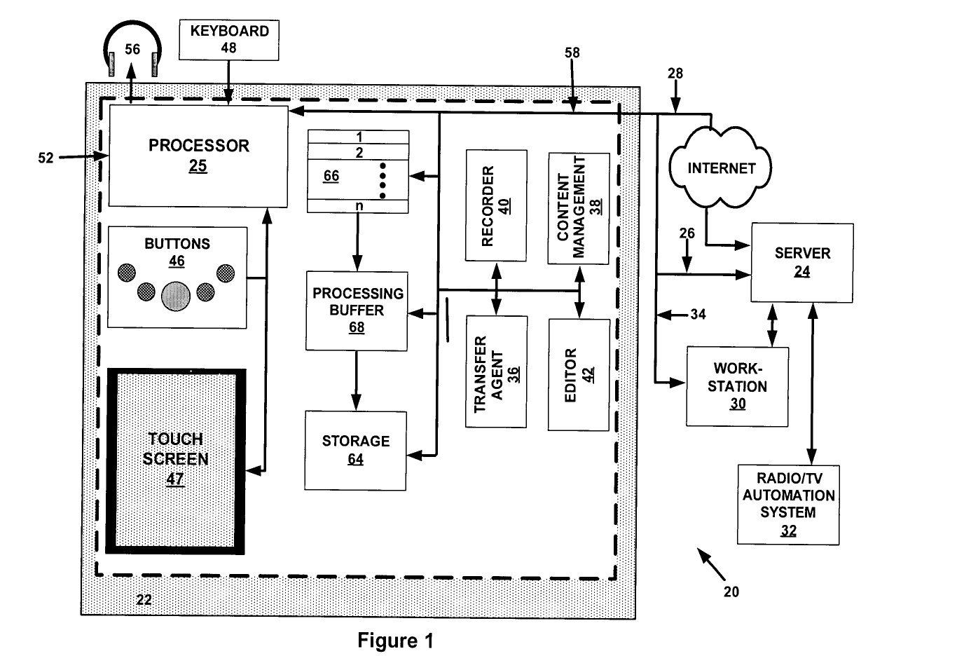

Referring to FIG. 1, an integrated system 20 for processing multimedia information in accordance with the present invention includes a programmable device 22 that is preferably small and lightweight. A personal digital assistant (PDA) such as the Compaq/HP IPAQ Model 5450 PocketPC is representative of a suitable device 22. Two-way communication between a server 24 and device 22 occurs by way of a direct connection 26 or a remote connection 28. Representative examples of direct connection 26 include, for example, wireless transceivers, direct media transfer and Ethernet or twisted-pair cable. A representative remote connection 28 includes the Internet, possibly functioning as a virtual private network. Server 24 may be a PC workstation or a fully configured server, depending on the technical requirements of the system. Server 24 includes information storage and retrieval capability, by means of which information can be imported or exported to other devices such as a desktop digital workstation 30 or a Radio or TV automation System 32. Information from PDA 22 may also be transferred directly into workstation 30 by a direct media transfer connection 34 such as a cable or wireless connection. As will be explained in more detail below, PDA 22 is provided with a computer program including a transfer agent module 36, a content management module 38, a recorder module 40 and an editor module 42. PDA 22 may communicate with server 24 through transfer agent module 36, and with workstation 30 through content management module 38 via a processor 25.

PDA 22 is preferably initially provided with a commercial operating system such as the Microsoft PocketPC/Windows Mobile Operating System. Other suitable operating systems include Microsoft Windows CE, the Palm and the Symbian operating system. While an operating system might be custom designed to work in coordination with a software application in accordance with the invention, it is contemplated that the invention will be implemented using the operating system provided with the PDA. Processor 25 receives information to be recorded on input 52. A signal to be recorded and processed by PDA 22 may be provided by any of several sources, for example, an external or internal microphone, a pre-amplifier, a sound card, coder, or a coder/decoder. Other information inputs to processor 25 are provided by programmable buttons 46 (discussed in more detail below), a touch screen 47, or an optional external keyboard 48, which provide commands for controlling the various processes performed by PDA 22. Outputs of PDA 22 include the previously identified direct connection 26, the remote connection 28, and the direct medium transfer connection 34. As is described in greater detail below, incoming data is received first in an allocated block of recording buffers 66. The data is later written to a processing buffer 68, then to non-volatile storage memory 64 for retention and further processing. It is to be understood that, while a preferred embodiment will likely have a block of recording buffers 66 as described above, the invention is equally applicable to any type of buffer handling that achieved a similar purpose. For example, a single long cyclic buffer may be used if one cycles through the buffer at regular periods and periodically empties and reuses previously used portions. The effect achieved is functionally equivalent to a “plurality” of buffers as described and claimed herein.

An application software package, the operation of which is described in more detail below, is preferably configured with four principal modules identified as a recorder module 40, a content management module 38, a transfer agent module 36, and an editor module 42. A particular module is selected by the operator, preferably using one of the programmable buttons 46 or touch screen 47. Commands for operating the module are preferably entered by means of graphical buttons (icons) via touch screen 47. Examples of such commands are start, stop, set marker, pause, resume, etc. Further information, such as titles and comments, is entered into recorder module 40 by keyboard 48 or touch screen 47. Dialogs are preferably provided via programming for real-time editing of metadata text and multimedia input or for ingest and output signal control, such as volume control and selection of compression level and other technical recording functions. Real-time input signal monitoring enables the immediate playback of the recorded material via a headset 56 for quality control.

Content management module 38 controls the receipt of information recorded by recorder module 40 for storage in PDA memory 64 and optional further processing during the recording or after the recording function ended. Content management module 38 is activated via a button 46 or touch screen 47. Keyboard 48 or touch screen 47 also permits entry of extended metadata such as author, program title, storyboard, other descriptive text, and rundown information. An input 58 permits attachment of existing data such as documents, images, video, or pre-recorded audio from third party applications or other external sources. More detailed editing of the previously recorded signal and alternative choices for data compression and format may be provided via a programmed dialog. Direct media transfer connection 34 permits information stored in PDA storage/memory to be relayed directly to back-end server 24 without utilizing the additional capabilities of transfer agent 36.

An editor module 42 provides the PDA operator with a full-featured multimedia editor capability, including, for example, cut, fade in/out, volume adjustments, non-destructive editing with undo and redo, clip generation, mixing and cross-fading. Specialized functions to extract the required parts of previous recordings are included, as are filters for quality improvement. Editor module 42 receives input data from content manager module 38 and/or recorder module 40 for processing, and the edited information is returned to content manager module 38 for storage management. A dialog 62 permits the operator to perform editing, data compression and format conversion by way of the PDA buttons 46, the keyboard 48 or touch screen 47. Multimedia editors having the above capabilities and suitable for operation on a processor such as is found in desktop multimedia workstation environments are well known in the art and will not be described in more detail here.

A transfer agent module 36 provides for menu-driven delivery of the stored data/signal, linked metadata and attachments in the PDA to an external recipient such as server 24. The transfer agent implements a step-by-step interactive procedure to cover the complete process of data transfer. Conventional I/O capabilities within the PDA permit transfer by direct connection 26 to server 24 or via the Internet by means of remote connection 28.

The transfer agent uses various conventional peripheral devices and transfer methods to implement all of the steps of data transfer into a seamless workflow. The transfer agent ensures data integrity in all steps of the content delivery, as well as processing of return information (ticketing/confirmation) from the back-end server 24.

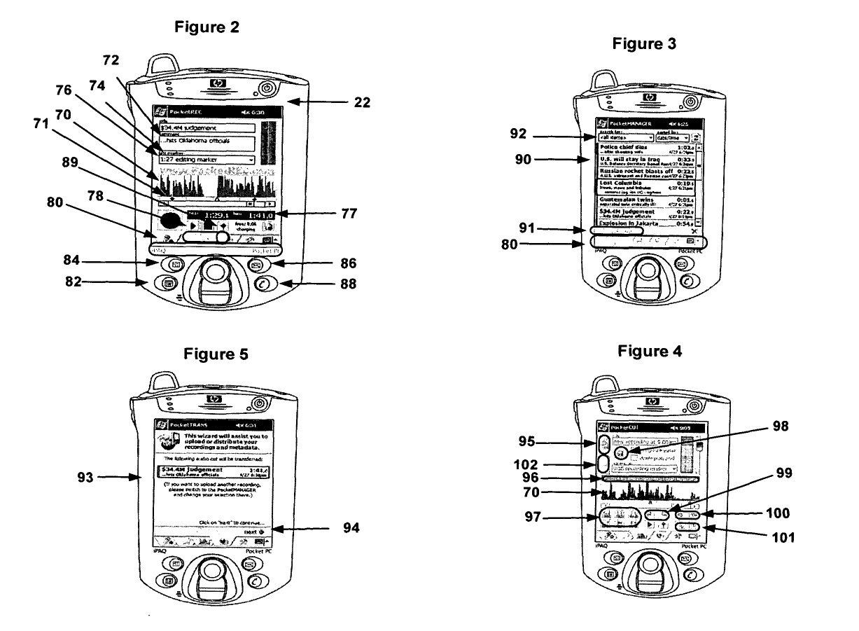

Referring to FIGS. 2-5, a PDA will display one of the four screens illustrated by way of example, depending on the module in use. In particular, FIG. 2 depicts a representative example of a PDA with the recorder module active, FIG. 3 depicts a representative example of a PDA with the content management module active, FIG. 4 depicts a representative example of a PDA with the multimedia editor module active, and FIG. 5 depicts a representative example of a PDA with the transfer agent module active. Touch screen module icons 80 permit the operator to select the desired module.

FIG. 2 depicts module icons 80, which are visible within all modules to enable an easily accessible switching between the components of the package. Programmable buttons 82, 84, 86 and 88 are assigned functions within the modules, either globally or within a certain operation mode. For example, recording button 84 might be programmed to set a marker, button 84 might be programmed to stop recording, and the buttons 82 and 88 might be programmed to toggle the display on and off during recording to save battery power.

As a signal is received during recording, a waveform representation 70 of the incoming audio signal is displayed in real time. Alternatively, the waveform may include other types of visually displayable digital information. The operator may monitor the graphical representation of the signal and, with the aid of touch screen icons such as at 71 or 89, insert markers to permit rapid finding of key sound bites or similar segments. Displayed waveforms 78 may be color coded to facilitate more rapid searches. The operator may, simultaneously, with the aid of an attached keyboard 48 or touch screen 47, insert metadata or markers. For example, a title 72 can be provided as the file name, additional descriptive information or comments 74 may be added, or additional marker information such as an individual marker title 76 may be included. A row of touch screen icons 78 allows the operator to perform basic playback operations such as start, pause, stop, set/delete marker etc. directly within the recorder module. Appropriate programming will preferably ensure that only the essential recording and playback functions are available to provide the user with an easily remembered instruction set that minimizes the likelihood of operator error. In the example illustrated in FIG. 2, a recording information line 77 indicates elapsed recording time, total length of the recording, and other important status information like the battery status and remaining storage capacity.

FIG. 3 illustrates a representative screen after data recording is completed and the operator has initiated content management mode by pressing the appropriate “content manager” icon 80. In this mode the operator may perform a complete range of editing functions on the data stored in memory or in the storage device. In the illustrated representative example, the operator has added text keyed to specific containers. For example, the entry field 90 indicates that a recorded segment having a length of 33 seconds, pertaining to the U.S. presence in Iraq, was recorded at 6:24 PM on April 27. The overview screen is designed to show the most important metadata for every container, while detailed metadata information can be accessed by one of the selectable editing screens via icon 91. By touching field 90, the operator selects this entry to initiate either the editing of the metadata within the content manager module 38, or, by handing over this container to one of the other modules via icon 80, e.g. for playback, appending a recording, multimedia editing or transfer.

The editing icons 91 allow the user to: assign metadata to a new recording that will be attached later (virtual entry); open the edit screen for changing detail metadata on an existing container; add attachments (e.g., other audio cuts, text, images, video); or delete the selected container. The search input and sort fields 92 allow navigating and fast access to the entire content storage.

FIG. 4 illustrates a sample screen for editor module 42. This module provides the operator a tool for the editing of digital files that have been recorded. Once a recording has been selected and loaded into the editor it is displayed as waveform representation 70. Title and marker information are also displayed in the text & file information field 95. A left editing icon 99 selects the beginning of a segment of text to be edited and a right editing marker 98 selects the end of a segment of text to be edited. During this selection process and at other times, the operator may choose to use the zoom function icons 101 (zoom in and zoom out) to assist in locating the exact points within the file to set the editing markers 99 and 98 . A primary editing function group 97 is available to the operator. Within the primary editing function group are the following functions; fade in and fade out; playback of the selected area only; playback by omitting the selected area; delete the data within the selected area and delete all data outside selected area. Each of these primary functions may be opened for more detailed processing and/or settings. The operator has the capability to perform an essentially unlimited number of “undo and redo” of the previous actions in the order of their execution with icon 100. During the entire editing session, file position information 96, measured and referenced in time relative to the initial recording is updated in real time. This includes: the exact position of the “in-point” and “out-point” of the operator selected area; the exact position of the middle reference of the display area of waveform representation 70 and the actual current length of the file. A working clipboard and additional related editing functions are also available for more detailed and precise editing under the Clipboard Tab 102. After completing the editing process, the operator is provided the options of marking the file as ready to transfer and/or marking the file for protection against deletion Thereafter, the operator is required to execute the “save” function icon 98 to retain the edited file and metadata container.

FIG. 5 illustrates a representative transfer module screen. This module is designed as a step-by-step container transfer wizard. Depending on the selected transfer protocol and transfer media, the user is guided through the necessary steps required to deliver the container to the selected destination. The transfer module ensures the integrity of the transferred material so that all transferred data is consistent through all steps of the process. For example, the first screen field 93 prompts the operator to select the correct container for transferring before continuing. After the operator has provided confirmation by selecting the “next” icon 94, following screen prompts the operator to select all or part(s) of the container for transfer, either with or without any attachments.

Next, the user selects a transfer protocol (e.g. FTP upload, e-mail, codec, etc.) and transfer media (e.g. wireless, wired, Internet, Intranet, VPN, etc.). Frequently used upload targets can be pre-configured and are presented by a graphical button for selection by the user. In the next screen, a compression format can be selected to speed up the transfer process via low bandwidth connections (e.g. MPEG1 layer 2 or layer 3 or the OGG Vorbis or Speex compression formats via GSM/CDMA/GPRS/3G etc. connections).

Further interactive dialogs are then presented to the operator, working through the required steps for the selected data transfer methods. Details such as asking whether a “9” or “0” must be dialed to make the connection to an outside line for a modem dial-up Internet connection are preferably included to ensure ease of operation. Once the physical connection is established in the next step, the transfer module automatically uploads the container to the selected destination. A graphical overview of the process continuously informs the operator about the current status.

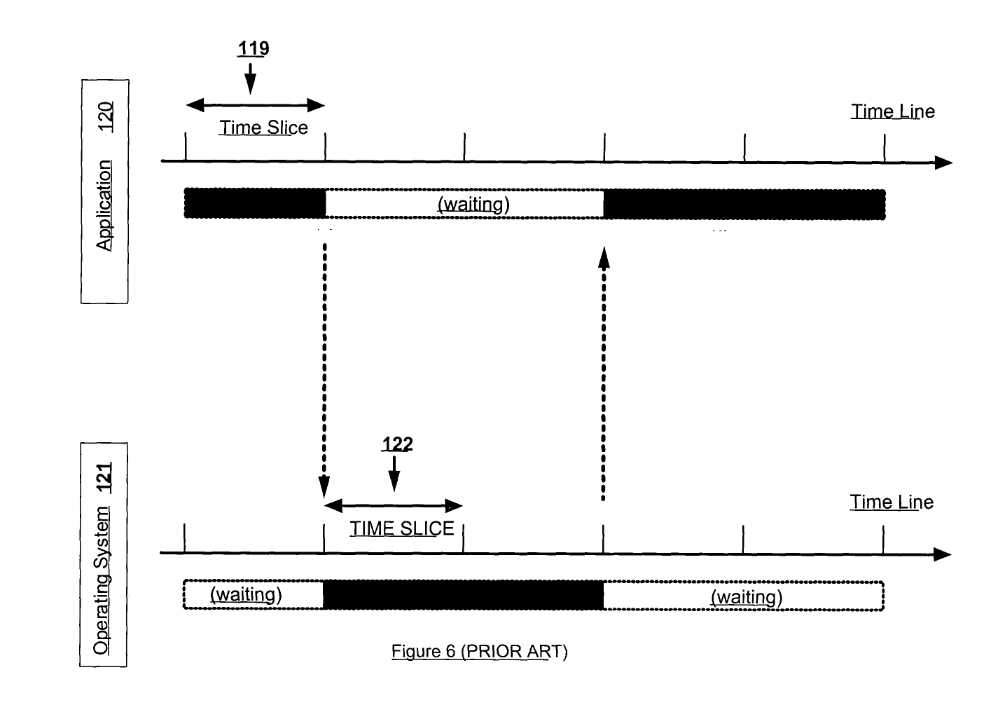

The timing diagram of FIG. 6 illustrates synchronous file I/O access as configured in present PDAs and their operating systems employing single threaded microprocessor architectures and software configured for optimum playback. In particular, FIG. 6 illustrates an example of the method of handling digital signal ingest and playback as implemented in current PDA environments. At least two thread layers are assigned to the available system resources, described here as application layer 120 and operating system layer 121. A time-slice 119 is defined as the processing resource that is assigned by the operating system and/or the processor exclusively to an individual process. At the end of the time-slice, the processor and/or operating system will switch its resources to the next process in order to simulate multi-threading on a single processor platform. During a typical ingest or playback, the application is required to execute a file I/O command 123 prior to the time the system must switch over to the operating system layer 121 to initiate the file execute command 124 in the next time slice 122. In many current operating system implementations, the file I/O execute command 124 is synchronized to the application layer 120, so the processing of the application layer 120 cannot continue until the file I/O execute command 124 has been completed.

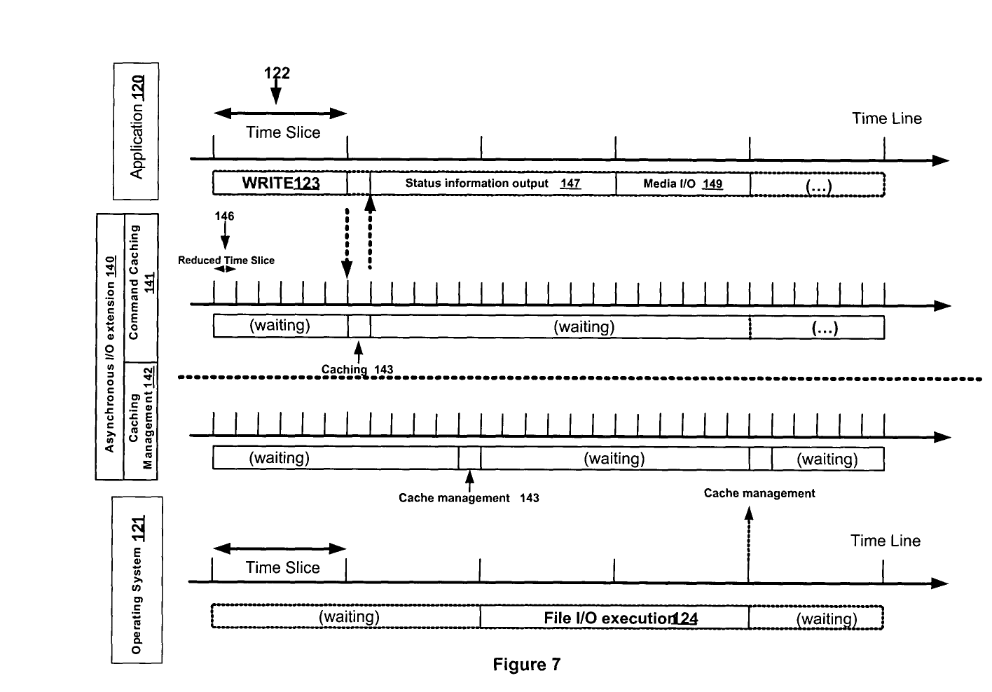

FIG. 7 illustrates an embodiment of the present invention that overcomes the above-identified disadvantages of the prior art. An asynchronous I/O extension layer 140 is inserted between application layer 120 and operating system layer 121 to uncouple them and change the synchronous file I/O write process into an asynchronous file I/O write process.

An asynchronous extension layer 140 consists of two sublayers, a command caching layer 141 and a caching management layer 142. In one embodiment of the invention, both sublayers 141 and 142 run under application layer 120 privileges. In a second embodiment of the invention, the command caching layer 141 runs under application layer 120 privileges and the management layer 142 runs under operating system layer 121 privileges. Due to the uncoupling, multiple attachments and detachments are made available (shorter time slices) to requesting processes therefore allowing the application layer more control and creating better performance resulting in a more stable application and system environment.

Asynchronous layer 140 uses timing slices 146 of shorter duration than timing slices 122 utilized at the application layer 120. Preferably, the duration of timing slice 146 is about ¼ or less the duration of timing slice 122. This significantly increases the response time of asynchronous layer 140 relative to application layer 120 and operating system layer 121.

During recording, the program on application layer 120 initiates a file I/O write command 123 to asynchronous I/O layer 140. Caching layer 141 receives the command and copies incoming data via a caching command 143. This operation takes place in local memory, and is processed very quickly, usually within one of the reduced time slice cycles 146 of asynchronous I/O layer 140. Caching layer 141 thus returns control to application layer 120 after one reduced time slice cycle 146, allowing for the execution of a real time status information command 147 or other media I/O handling command 149 to occur without regard to events occurring at operating system layer 121.

Caching management layer 142 collects the incoming and buffered I/O write command from the caching layer 141 during interval 144. When a predetermined buffer size is exceeded, the contents of the buffers are streamed directly to a selected internal or external storage medium within one unsegmented file I/O operation. Because the resulting file I/O execution 124 is only connected to the management layer 142, the application layer 120 is not directly affected by potential blocking of the synchronous file I/O operation on the operating system layer 121.

Optimized and dynamically expandable data structures are effectively utilized in the timing and cache implementation of command caching layer 141 and caching management layer 142 to prevent the blocking of the caching layer due to the synchronous file I/O execution 124 within the operating system layer 121.

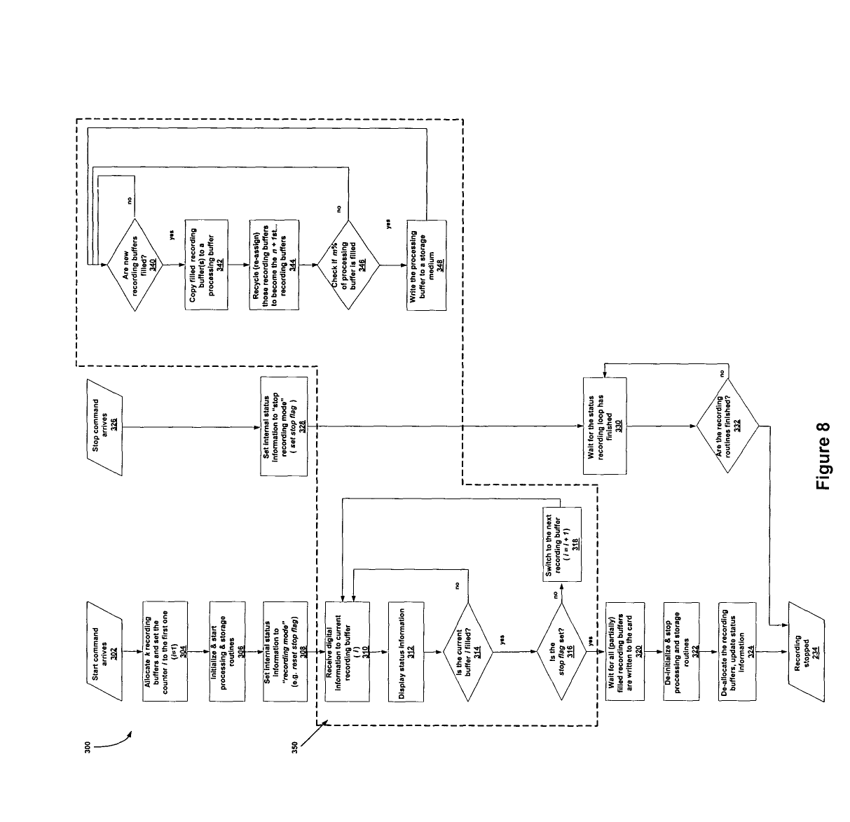

Referring to FIG. 8, a flowchart depicting a file I/O access operation and control flow process 300 according to an embodiment of the invention is shown. Process 300 beings at step 302 with receipt of an operator-initiated record start command. A group of n recording buffers 66 (FIG. 1) is allocated and a counter is reset to point to the first buffer. The counter function may be provided via programming within processor 25. Recording data processing and storage routines are initialized at step 306. At step 308, internal status information is reset. Typical of such information is resetting a stop flag that will indicate when recording has been concluded, starting a recording clock, and erasing markers from previous recording sessions. Incoming data to be recorded begins to fill the first buffer at step 310. Step 312 provides for real time display of the incoming signal waveform. The filling of the current recording buffer is queried at step 314 to determine whether it is full. If it is not yet full, the process returns to step 310 and filling of the current recording buffer continues. The logical function of monitoring and querying the contents of the recording and processing buffers may be provided by programming within processor 25. If yes, the counter is incremented at step 318 and the next recording buffer begins to fill as the process returns to step 310. The switching function for moving the receipt of incoming information from one recording buffer to another may be provided by programming within processor 25. Alternatively, the switching between buffers may occur in a soundcard associated with the PDA or in a driver of an extension accessory card. When the stop flag at step 314 indicates that recording is complete, partially filled buffers are written to memory at step 320. Processing and storage routines are stopped at step 322. The n recording buffers are de-allocated and final updating of the status information occurs in step 324, after which the complete recording function is ended, step 334.

Simultaneously with steps 302 through 324, a separate software routine executes a process for transferring digital data from the recording buffers to the processing buffer and then to non-volatile memory, beginning with step 340. At step 340, the recording buffers are continuously queried to determine whether any are filled. If not, the query process continues. When a filled recording buffer is detected, the filled recording buffer, or all filled recording buffers if more than one is filled, is sequentially copied to the processing buffer at step 342. Once the contents of a recording buffer have been copied, the buffer is reallocated at step 344, or released and allocated again at step 344, and effectively becomes the n+1^{st} available recording buffer. This reallocation process significantly reduces the size of the value n, the number of buffers that must be initially dedicated to the recording process at step 304. Use of the limited PDA memory is thereby optimized. When a predetermined percentage of the processing buffer is filled, as determined by a query in step 346, the contents of the processing buffer are written to a non-volatile storage medium at step 348. If the query of step 346 indicates that the processing buffer has not yet been filled to the predetermined amount, the process continues at step 340.

Also in parallel with the immediately preceding processes described in steps 302 through 318 and steps 340 through 348, a third process is initiated upon the receipt of a recording stop command at step 326. The stop flag is set at step 328, which initiates the process beginning at step 320 to complete the transfer of the contents of partially filled recording buffers to the processing buffer. Step 330 is a delay step, during which the progress of the transfer of all data to the storage medium is queried at step 332. If the query at step 332 indicates that processing has not completed, the process continues at step 330. When the query at step 332 indicates that processing is complete, the recording function is ended at step 334.

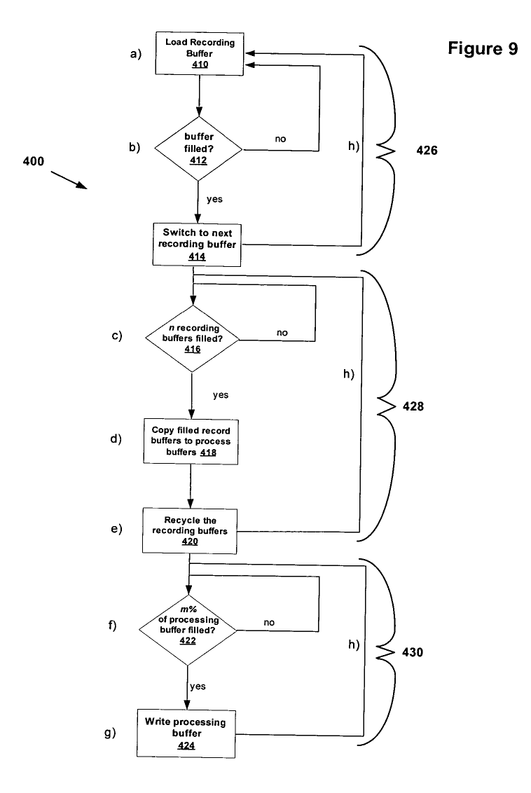

FIGS. 9-12 illustrate alternative embodiments of the process described above with respect to FIG. 8. The primary differences in the alternative embodiments described below are in the processing steps that occur within the area 350 of FIG. 8. For purposes of understanding the invention, it should be understood that the remaining process steps depicted in FIG. 8 could also be a part of the processes described below with respect to FIGS. 9-12.

Referring to FIG. 9, a flowchart depicting a file I/O access operation and control flow process 400 according to an embodiment of the invention is shown. Process 400 begins at step 410 when the operator initiates recording and digital information is received in a first recording buffer. In step 412, the filling of the buffer is monitored until, upon a determination that the first buffer is filled, the input switches to a second buffer at step 414 and the process continues at step 410. The sequence continues with the filling of additional recording buffers so long as recording continues. Simultaneously with the filling of the recording buffers, in steps 410-414, the status of the recording buffers is queried in step 416 to determine whether some predetermined number p of recording buffers have been filled. The number p will be less than the total number n of allocated recording buffers, n/2<p<n, with the variable depending on the type or size of the selected storage medium. If the requisite number of recording buffers has not been filled, the process continues at step 416. Copying of the filled recording buffers to a processing buffer is initiated at step 418 when the requisite number of filled recording buffers is detected. After the contents of each recording buffer have been transferred, the buffer is reallocated and/or released and made available for further allocation and becomes available at step 420 for receipt of additional digital information as required. In step 422, the filling of the processing buffer is monitored. When a predetermined portion of the buffer is filled, the contents are written to permanent storage in step 424. An appropriate portion or percentage may be >50%, with the variable depending on the type or size of the selected storage medium.

Note that process 400 does not occur linearly from step 410 through 424; instead, the process may occur in parallel segments. In particular, process segment 426 may proceed simultaneously with initiation of process segment 428. Similarly, process segment 430 may proceed in parallel with both segments 426 and 428.

The process of FIG. 9 may also be performed with the several recording buffers (1−n) 56 of FIG. 1 being replaced by a single large recording buffer. It is well known in the art that an optimum buffer size may be easily calculated from the chosen bit resolution, period of time for the recording, and sampling rate of the incoming digital information stream at input 52. In an alternative embodiment of the invention utilizing a single large buffer, a buffer segment size is calculated and the large buffer is apportioned into a number of buffer segments. Segmentation is performed by programming, with pointers indicating the beginning and end of each segment.

The process begins at step 410 when the operator initiates recording and digital information is received in a first recording buffer segment of the single large recording buffer. In step 412, the filling of the buffer segment is monitored until, upon a determination that the first buffer segment is filled, the pointer moves to a second buffer segment at step 414 and the process continues at step 410. The sequence continues with the filling of additional recording buffer segments. Simultaneously with the filling of the recording buffer segments, in steps 410-414, the status of the recording buffer segments is queried in step 416 to determine whether some predetermined number p of recording buffer segments have been filled. The number p will be less than the total number n of allocated recording buffer segments, n/2<p<n, with the variable depending on the type or size of the selected storage medium. If the requisite number of recording buffer segments has not been filled, the process continues at step 416. Copying of the filled recording buffer segments to a processing buffer is initiated at step 418 when the requisite number of filled recording buffer segments is detected. After the contents of each recording buffer segment have been transferred, the buffer segment is reallocated and/or released and made available for further allocation and becomes available at step 420 for receipt of additional digital information as required. In step 422, the filling of the processing buffer is monitored. When a predetermined portion of the buffer is filled, the contents are written to permanent storage in step 424. An appropriate portion or percentage may be >50%, with the variable depending on the type or size of the selected storage medium.

Note that process 400 does not occur linearly from step 410 through 424; instead, the process may occur in parallel segments. In particular, process segment 426 may proceed simultaneously with initiation of process segment 428. Similarly, process segment 430 may proceed in parallel with both segments 426 and 428.

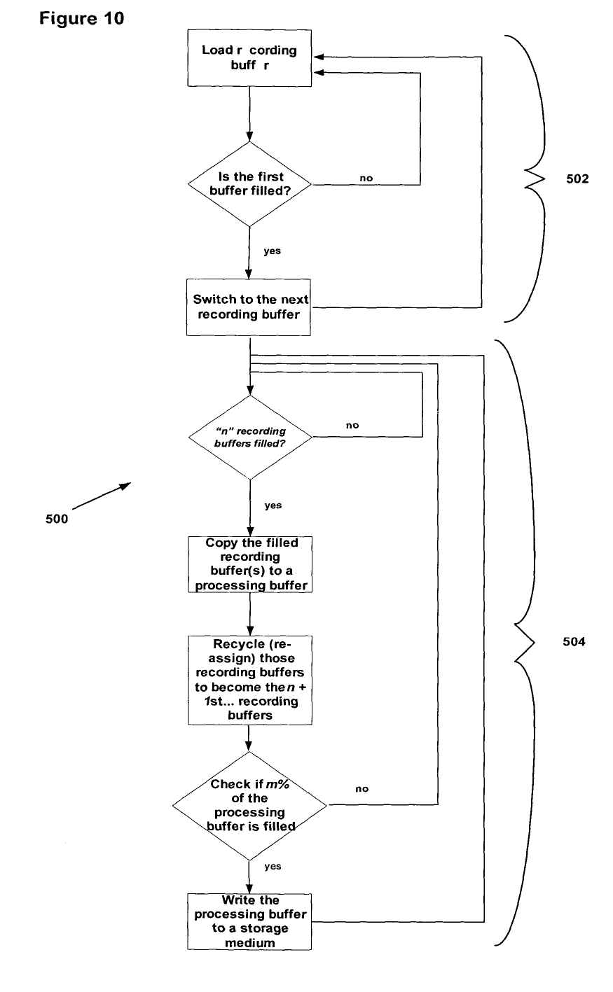

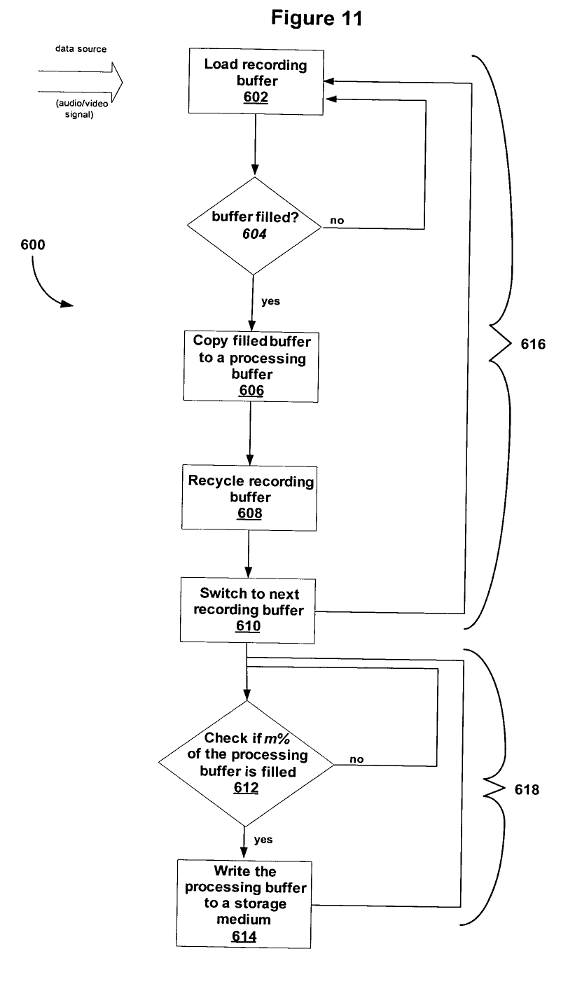

Referring to FIG. 10, a flowchart depicting an alternative file I/O access operation and control flow process 500 according to an embodiment of the invention is shown. Process 500 differs from the previously described process 400 of FIG. 9 in that process segments 428 and 430 of FIG. 10 are combined in a single process segment 504 in FIG. 10. Process segment 504 may occur in parallel with process segment 502.

Referring to FIG. 11, a flowchart depicting an alternative file I/O access operation and control flow process 600 according to an embodiment of the invention is shown. In step 602, incoming digital data is loaded into an allocated recording buffer. The loading is monitored at step 604 to determine whether it is filled. If not, the process continues at step 602. When the buffer is filled, its contents are copied into a processing buffer at step 606. After copying is completed, the recording buffer is re-allocated at step 608 and again made available for receipt of incoming data. At step 610, the process switches the incoming data to the next available recording buffer and the process continues at step 602. Simultaneously with steps 602-610, the processing buffer is queried at step 612 to determine whether a predetermined percentage m or amount of the buffer is filled. If not, the process continues at step 612. When the predetermined percentage m is reached, the contents of the processing buffer are written to a storage medium at step 614. The process continues at step 612.

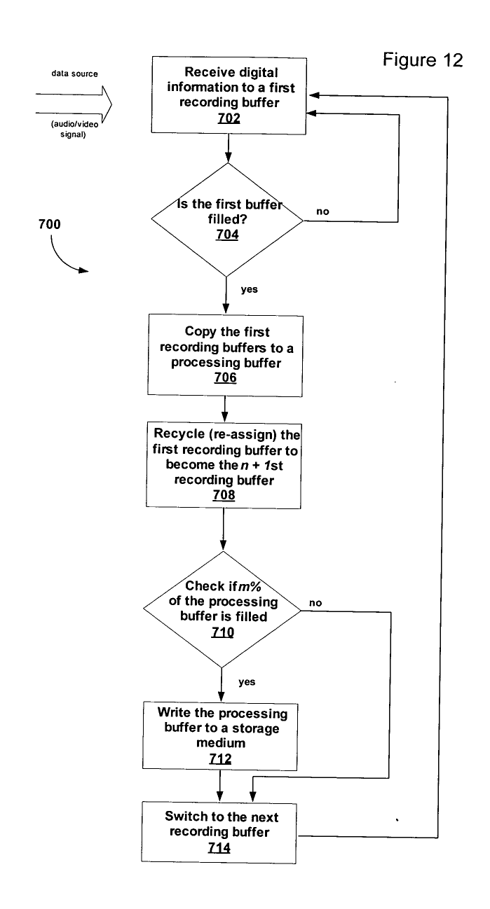

Referring to FIG. 12, a flowchart depicting an alternative file I/O access operation and control flow process 700 according to an embodiment of the invention is shown. Process 700 differs from the previously described process 600 of FIG. 11 in that process segments 616 and 618 of FIG. 11 are combined in a single process in FIG. 12.

As described above, the present invention has utility for news reporting and other journalistic activities. Among the many other activities in which the invention will find wide application are: a) use as a “live recording and transmission device for sports, music, and similar entertainment events; b) use as a portable workstations employed in theme parks for a wireless sound/video control and playback system; c) use as a portable device for viewing and listening of prepared programming that could be used in museums, theme parks or visitor centers; d) use in hospitals or other medical environments for nurses, doctors and administrators to record interviews with patients, medical instructions, prescription information and audio notes for later transcription into text for transfer into medical and billing records; e) use in law enforcement applications as high quality audio coupled with metadata and images for support of investigation and daily violation reporting, serving as “for the record” filings, as automated entry to fines and fees systems and into driver point systems and further processing and transfer into other law enforcement and justice systems and databases; f) use, as with law enforcement, in homeland security agency and intelligence communities; g) use for professional recording of music at live performances and in recording studios; and h) use as the basis for high quality audio-to-text transcription.

In any or all of the aforementioned, the invention may be embodied in any, some or all of the following forms: it may be embodied in a method of operating a computer system; it may be embodied in the computer system itself; it may be embodied in a computer system when programmed with or adapted or arranged to execute the method of operating that system; and/or it may be embodied in a computer-readable storage medium having a program recorded thereon which is adapted to operate according to the method of operating the system. While the preferred forms and embodiments of the invention have been illustrated and described, it will be apparent to those of ordinary skill in the art that various changes and modification may be made without deviating from the inventive concepts set forth above.

1. A method of processing digital information comprising the steps of:
(a) receiving digital information at an input connected to a recording buffer;
(b) filling the recording buffer with information; and
(c) simultaneously with steps (a) through (b),
(i) monitoring the recording buffer to determine whether it is filled;
(ii) transferring the contents of the filled recording buffer to a processing buffer;
(iii) monitoring the processing buffer to determine whether a predetermined amount of the processing buffer is filled; and
(iv) writing the contents of the processing buffer to a storage medium when a predetermined amount of the processing buffer has been filled.

2. The method of claim 1, and further comprising the step of displaying status information pertaining to the digital information on a display.

3. The method of claim 2, and further comprising the step of displaying a real time waveform of the digital information.

4. The method of claim 3, and further comprising the step of marking selected portions of the waveform.

5. The method of claim 4, and further comprising the step of displaying the markers concurrently with the waveform.

6. The method of claim 5, and further comprising the step of color-coding the waveforms.

7. The method of claim 1, and further comprising the step of reallocating each recording buffer as available for receipt of digital information after its contents have been written to the processing buffer.

8. A method of processing digital information comprising the steps of:
(a) receiving digital information at an input connected to a recording buffer segment;
(b) filling the recording buffer segment with information; and
(c) simultaneously with steps a through b,
(i) monitoring the recording buffer segment to determine whether it is filled;
(ii) transferring the contents of the filled recording buffer segment to a processing buffer;
(iii) monitoring the processing buffer to determine whether a predetermined amount of the processing buffer is filled; and
(iv) writing the contents of the processing buffer to a storage medium when a predetermined amount of the processing buffer has been filled.

9. The method of claim 8, and further comprising the step of displaying status information pertaining to the digital information on a display.

10. The method of claim 9, and further comprising the step of displaying a real time waveform of the digital information.

11. The method of claim 10, and further comprising the step of marking selected portions of the waveform.

12. The method of claim 11, and further comprising the step of displaying the markers concurrently with the waveform.

13. The method of claim 12, and further comprising the step of color-coding the waveforms.

14. The method of claim 8, and further comprising the step of reallocating each recording buffer segment as available for receipt of digital information after its contents have been written to the processing buffer.

15. A method of processing digital information comprising the steps of:
(a) receiving digital information at an input switchably connected to a plurality of recording buffers;
(b) sequentially filling the recording buffers with information; and
(c) simultaneously with steps (a) through (b),
(i) monitoring the recording buffers to determine whether any recording buffer is filled;
(ii) sequentially transferring the contents of each filled recording buffer to a processing buffer;
(iii) monitoring the processing buffer to determine whether a predetermined amount of the processing buffer is filled; and
(iv) writing the contents of the processing buffer to a storage medium when a predetermined amount of the processing buffer has been filled.

16. The method of claim 15, and further comprising the step of displaying status information pertaining to the digital information on a display.

17. The method of claim 16, and further comprising the step of displaying a real time waveform of the digital information.

18. The method of claim 17, and further comprising the step of marking selected portions of the waveform.

19. The method of claim 18, and further comprising the step of displaying the markers concurrently with the waveform.

20. The method of claim 19, and further comprising the step of color-coding the waveforms.

21. The method of claim 15, and further comprising the step of reallocating each recording buffer as available for receipt of digital information after its contents have been written to the processing buffer.

22. A method of processing digital information comprising the steps of:
(a) receiving digital information at an input switchably connected to a plurality of recording buffers;
(b) sequentially filling the recording buffers with information; and
(c) simultaneously with steps (a) through (b),
(i) monitoring the recording buffers to determine whether any recording buffer is filled;
(ii) sequentially transferring the contents of each filled recording buffer to a processing buffer;
(iii) monitoring the processing buffer to determine whether a predetermined amount of the processing buffer is filled;
(iv) writing the contents of the processing buffer to a storage medium when a predetermined amount of the processing buffer has been filled; and
(d) simultaneously with steps (a) through (c), monitoring the receipt of digital information to determine when receipt of digital information is completed and, upon such determination:
(i) sequentially transferring the contents of each filled and unfilled recording buffer to the processing buffer; and
(ii) writing the contents of the processing buffer to a storage medium.

23. The method of claim 22, and further comprising the step of displaying status information pertaining to the digital information on a display.

24. The method of claim 23, and further comprising the step of displaying a real time waveform of the digital information.

25. The method of claim 24, and further comprising the step of marking selected portions of the waveform.

26. The method of claim 25, and further comprising the step of displaying the markers concurrently with the waveform.

27. The method of claim 26, and further comprising the step of color-coding the waveforms.

28. The method of claim 22, and further comprising the step of reallocating each recording buffer as available for receipt of digital information after its contents have been written to the processing buffer.

29. A method of processing digital information comprising the steps of:
(a) receiving digital information at an input switchably connected to a plurality of recording buffers;
(b) sequentially filling the recording buffers with information; and
(c) simultaneously with steps (a) through (b),
(i) monitoring the recording buffers to determine whether a predetermined number of recording buffers are filled;
(ii) sequentially transferring the contents of each filled recording buffer to a processing buffer; and
(d) simultaneously with steps (a) through (c),
(i) monitoring the processing buffer to determine whether a predetermined amount of the processing buffer is filled; and
(ii) writing the contents of the processing buffer to a storage medium when a predetermined amount of the processing buffer has been filled.

30. The method of claim 29, and further comprising the step of displaying status information pertaining to the digital information on a display.

31. The method of claim 30, and further comprising the step of displaying a real time waveform of the digital information.

32. The method of claim 31, and further comprising the step of marking selected portions of the waveform.

33. The method of claim 32, and further comprising the step of displaying the markers concurrently with the waveform.

34. The method of claim 33, and further comprising the step of color-coding the waveforms.

35. The method of claim 29, and further comprising the step of reallocating each recording buffer as available for receipt of digital information after its contents have been written to the processing buffer.

36. A method of processing digital information comprising the steps of:
(a) receiving digital information at an input switchably connected to a plurality of recording buffers;
(b) sequentially filling the recording buffers with information;
(c) sequentially transferring the contents of each filled recording buffer to a processing buffer; and
(d) simultaneously with steps (a) through (c),
(i) monitoring the processing buffer to determine whether a predetermined amount of the processing buffer is filled; and
(ii) writing the contents of the processing buffer to a storage medium when a predetermined amount of the processing buffer has been filled.

37. The method of claim 36, and further comprising the step of displaying status information pertaining to the digital information on a display.

38. The method of claim 37, and further comprising the step of displaying a real time waveform of the digital information.

39. The method of claim 38, and further comprising the step of marking selected portions of the waveform.

40. The method of claim 39, and further comprising the step of displaying the markers concurrently with the waveform.

41. The method of claim 40, and further comprising the step of color-coding the waveforms.

42. The method of claim 36, and further comprising the step of reallocating each recording buffer as available for receipt of digital information after its contents have been written to the processing buffer.

43. A method of processing digital information comprising the steps of:
(a) receiving digital information at an input switchably connected to a plurality of recording buffers;
(b) filling a recording buffer with information;
(c) monitoring the recording buffers to determine whether a recording buffer is filled;
(d) transferring the contents of a filled recording buffer to a processing buffer;
(e) monitoring the processing buffer to determine whether a predetermined amount of the processing buffer is filled;
(f) writing the contents of the processing buffer to a storage medium; and
(g) switching to a next recording buffer for filling.

44. The method of claim 43, and further comprising the step of displaying status information pertaining to the digital information on a display.

45. The method of claim 44, and further comprising the step of displaying a real time waveform of the digital information.

46. The method of claim 45, and further comprising the step of marking selected portions of the waveform.

47. The method of claim 46, and further comprising the step of displaying the markers concurrently with the waveform.

48. The method of claim 47, and further comprising the step of color-coding the waveforms.

49. The method of claim 43, and further comprising the step of reallocating each recording buffer as available for receipt of digital information after its contents have been written to the processing buffer.

50. A PDA program product comprising a PDA usable medium having control logic stored therein for causing a PDA to record digital multimedia information, said control logic comprising:
(a) PDA readable program code means for causing the PDA to receive digital information at an input connected to a recording buffer;
(b) PDA readable program code means for causing the PDA to fill the recording buffer with information;
(c) PDA readable program code means for causing the PDA to monitor the recording buffer to determine whether it is filled;
(d) PDA readable program code means for causing the PDA to transfer the contents of the filled recording buffer to a processing buffer;
(e) PDA readable program code means for causing the PDA to monitor the processing buffer to determine whether a predetermined amount of the processing buffer is filled; and
(f) PDA readable program code means for causing the PDA to write the contents of the processing buffer to a storage medium when a predetermined amount of the processing buffer has been filled.

51. A PDA program product comprising a PDA usable medium having control logic stored therein for causing a PDA to record digital multimedia information, said control logic comprising:
(a) PDA readable program code means for causing the PDA to receive digital information at an input connected to a recording buffer segment;
(b) PDA readable program code means for causing the PDA to fill the recording buffer segment with information;
(c) PDA readable program code means for causing the PDA to monitor the recording buffer segment to determine whether it is filled;
(d) PDA readable program code means for causing the PDA to transfer the contents of the filled recording buffer segment to a processing buffer;
(e) PDA readable program code means for causing the PDA to monitor the processing buffer to determine whether a predetermined amount of the processing buffer is filled; and
(f) PDA readable program code means for causing the PDA to write the contents of the processing buffer to a storage medium when a predetermined amount of the processing buffer has been filled.

52. A PDA program product comprising a PDA usable medium having control logic stored therein for causing a PDA to record digital multimedia information, said control logic comprising:
(a) PDA readable program code means for causing the PDA to receive digital information at an input switchably connected to a plurality of recording buffers;
(b) PDA readable program code means for causing the PDA to sequentially fill the recording buffers with information;
(c) PDA readable program code means for causing the PDA to monitor the recording buffers to determine whether any recording buffer is filled;
(d) PDA readable program code means for causing the PDA to sequentially transfer the contents of each filled recording buffer to a processing buffer;
(e) monitor the processing buffer to determine whether a predetermined amount of the processing buffer is filled; and
(f) PDA readable program code means for causing the PDA to write the contents of the processing buffer to a storage medium when a predetermined amount of the processing buffer has been filled.

53. A PDA program product comprising a PDA usable medium having control logic stored therein for causing a PDA to record digital multimedia information, said control logic comprising:
(a) PDA readable program code means for causing the PDA to receive digital information at an input switchably connected to a plurality of recording buffers;
(b) PDA readable program code means for causing the PDA to sequentially fill the recording buffers with information;
(c) PDA readable program code means for causing the PDA to monitor the recording buffers to determine whether any recording buffer is filled;
(d) PDA readable program code means for causing the PDA to sequentially transfer the contents of each filled recording buffer to a processing buffer;
(e) PDA readable program code means for causing the PDA to monitor the processing buffer to determine whether a predetermined amount of the processing buffer is filled;
(f) PDA readable program code means for causing the PDA to write the contents of the processing buffer to a storage medium when a predetermined amount of the processing buffer has been filled;
(g) PDA readable program code means for causing the PDA to monitor the receipt of digital information to determine when receipt of digital information is completed,
(h) PDA readable program code means for causing the PDA to, upon such determination, sequentially transfer the contents of each filled and unfilled recording buffer to the processing buffer; and
(i) PDA readable program code means for causing the PDA to write the contents of the processing buffer to a storage medium.

54. A PDA program product comprising a PDA usable medium having control logic stored therein for causing a PDA to record digital multimedia information, said control logic comprising:
(a) PDA readable program code means for causing the PDA to receive digital information at an input switchably connected to a plurality of recording buffers;
(b) PDA readable program code means for causing the PDA to sequentially fill the recording buffers with information;
(c) PDA readable program code means for causing the PDA to monitor the recording buffers to determine whether a predetermined number of recording buffers are filled;
(d) PDA readable program code means for causing the PDA to sequentially transfer the contents of each filled recording buffer to a processing buffer;
(e) PDA readable program code means for causing the PDA to monitor the processing buffer to determine whether a predetermined amount of the processing buffer is filled; and
(f) PDA readable program code means for causing the PDA to write the contents of the processing buffer to a storage medium when a predetermined amount of the processing buffer has been filled.

55. A PDA program product comprising a PDA usable medium having control logic stored therein for causing a PDA to record digital multimedia information, said control logic comprising:
(a) PDA readable program code means for causing the PDA to receieve digital information at an input switchably connected to a plurality of recording buffers;
(b) PDA readable program code means for causing the PDA to sequentially fill the recording buffers with information;
(c) PDA readable program code means for causing the PDA to sequentially transfer the contents of each filled recording buffer to a processing buffer;
(d) PDA readable program code means for causing the PDA to monitor the processing buffer to determine whether a predetermined amount of the processing buffer is filled; and
(e) PDA readable program code means for causing the PDA to write the contents of the processing buffer to a storage medium when a predetermined amount of the processing buffer has been filled.

56. A PDA program product comprising a PDA usable medium having control logic stored therein for causing a PDA to record digital multimedia information, said control logic comprising:
(a) PDA readable program code means for causing the PDA to receive digital information at an input switchably connected to a plurality of recording buffers;
(b) PDA readable program code means for causing the PDA to fill a recording buffer with information;
(c) PDA readable program code means for causing the PDA to monitor the recording buffers to determine whether a recording buffer is filled;
(d) PDA readable program code means for causing the PDA to transfer the contents of a filled recording buffer to a processing buffer;
(e) PDA readable program code means for causing the PDA to monitor the processing buffer to determine whether a predetermined amount of the processing buffer is filled;
(f) PDA readable program code means for causing the PDA to write the contents of the processing buffer to a storage medium; and
(g) PDA readable program code means for causing the PDA to switch to a next recording buffer for filling.
